(19) United States
(12) Patent Application Publication
(10) Pub. No.: US 2003/0098866 A1
(43) Pub. Date: May 29, 2003

(54) Apparatus and method for controlling a stereo 3D display using BITBLT operation

(76) Inventor: Ruen-Rone Lee, Hsinchu (TW)

Correspondence Address: BIRCH STEWART KOLASCH & BIRCH, PO BOX 747, FALLS CHURCH, VA, 22040-0747, US

(21) Appl. No.: 09/995,689

(22) Filed: Nov. 29, 2001

(51) Int. Cl. G09G 5/399

(52) U.S. Cl. 345/539

(57) ABSTRACT

An apparatus for controlling a stereo 3D display includes an on-screen buffer, two off-screen buffers and a stereo window controller. The on-screen buffer stores screen image data including window image data. The two off-screen buffers are of a double-buffer architecture, wherein one off-screen buffer stores the left image data and the right image data of a current frame, and another off-screen buffer stores the left image data and the right image data of the next frame of the current frame. The stereo window controller controls swap operations and BITBLT (Bit Block Transfer) operations. The swap operations determine which one of the two off-screen buffers stores the left image data and the right image data of the current frame. The BITBLT operations alternatively transfer the left image data and the right image data of the current frame to the on-screen buffer as the window image data.

### BACKGROUND OF THE INVENTION

1. Field of the Invention

The invention relates to an apparatus and method for controlling a display and, in particular, to an apparatus and method for controlling a stereo 3D display using BITBLT (Bit Block Transfer) operations.

2. Related Art

In order that a viewer can view a scene correctly using a stereo 3D effect, two eyes of the viewer must see the scene from a slightly different perspective respectively. Each eye, in reality and in virtual reality, sees a different image of view. Then, after the mind “fuses” the two different images observed by different eyes, the observer sees a 3D stereoscopic image.

There are some techniques that can be used to make sure each eye sees the image that was created for it, that is, the left eye sees the left image, and the right eye sees the right image. Take a synchronized shutter glasses for example, the wearer looks through the LCD shutter glasses while the LCD “shutters” on and off, alternately showing the left eye only the left image, and the right eye only the right image. If the system is properly designed, the shutter switches on and off so quickly that one's mind fuses the two images into a single stereoscopic image.

When it comes to stereo 3D animation, a plurality of frames are displayed for the viewer in sequence, and each frame has a left image and a right image. Referring to FIG. 5 and FIG. 6, a conventional 3D animation technique provides two memory blocks 51 and 52 with full-screen sizes in the video memory of a video card. The memory blocks 51 and 52 store a left image and a right image respectively, and the image shown on the display is alternatively referred to the left image stored in the memory block 51 and the right image stored in the memory block 52. FIG. 5 shows the situation of the image shown on the display, referred to the left image stored in the memory block 51, and FIG. 6 shows the situation of the image shown on the display, referred to the right image stored in the memory block 52.

While displaying different images, a synchronized shutter glasses 2 performs a switching operation synchronously, so that the left eye of a viewer views only the left image, and the right eye of the viewer views only the right image.

One disadvantage of the above-mentioned conventional technique is that the stereo 3D animation is displayed in full screen mode on a display, and cannot be displayed in a window under an OS window environment. That is because the memory blocks 51 and 52 are of full-screen sizes, and all left images and right images of the animation are full-screen images, the screen cannot display other windows or icons on the display while displaying the stereo 3D animation.

Due to the limitation that only full-screen mode can be displayed, the stereo 3D animation displayed using conventional method cannot be used in conjunction with other software applications. For example, while designing a new mechanism using a CAD system, the engineer may simulate the dynamic characteristics and conditions of the mechanism using the stereo 3D animation in one window, and tuning various parameters of the mechanism according to the simulation result in another window. If those two windows can be displayed simultaneously, the engineer can monitor the simulation and tune the design parameters at the same time, which reduces the time required for designing the mechanism significantly. However, since the stereo 3D animation in the prior art must be displayed in full-screen mode, the animation window and the parameter-analyzing window cannot be displayed at the same time.

### SUMMARY OF THE INVENTION

In view of the above, an objective of the invention is to provide an apparatus and method for controlling a display, which control the display so that a stereo 3D animation can be displayed in a window.

To achieve the above-mentioned objective, the apparatus for controlling a stereo 3D display according to the invention includes an on-screen buffer, two off-screen buffers and a stereo window controller. The on-screen buffer stores screen image data including window image data. The two off-screen buffers constitute a double-buffer, wherein one off-screen buffer stores the left image data and the right image data of a current frame, and another off-screen buffer stores the left image data and the right image data of the next frame of the current frame. The stereo window controller controls swap operations and BITBLT (Bit Block Transfer) operations. The swap operations determine which one of the two off-screen buffers stores the left image data and the right image data of the current frame. The BITBLT operations alternatively transfer the left image data and the right image data of the current frame to the on-screen buffer as the window image data.

According to one aspect of the invention, a 3D graphics engine prepares the left image data and the right image data of the current frame, and the stereo window controller controls the swap operations according to swap signals from the 3D graphics engine. The 3D graphics engine sends a swap signal after the left image data and the right image data of the next frame are fully prepared.

According to another aspect of the invention, the stereo window controller considers vertical retraces of the stereo 3D display while controlling the BITBLT operations. That is, the BITBLT operation is performed after the vertical retrace, and there will be no other BITBLT operation until the next vertical retrace takes place.

According to still another aspect of the invention, a memory controller performs the BITBLT operations according to requests from the stereo window controller.

The invention also provides a method for controlling a stereo 3D display, which stores the left image data and the right image data of a current frame in one off-screen buffer and prepares the left image data and the right image data of the next frame of the current frame in another off-screen buffer. The left image data and the right image data of the current frame are alternatively transferred to an on-screen buffer by BITBLT operations as window image data. A swap operation is performed to swap the off-screen buffer storing the left image data and the right image data of the current frame.

After the left image data and the right image data of the next frame are fully prepared, the next frame is set as the current frame, and the frame posterior to the next frame is set as the next frame.

By utilizing the double buffer architecture and using the stereo window controller to coordinate the buffer swap operations, the BITBLT operations and the vertical retraces, the apparatus and method for controlling a stereo 3D display according to the invention can display a stereo 3D animation in a window.

### BRIEF DESCRIPTION OF THE DRAWINGS

These and other features, aspects and advantages of the invention will become better understood with regard to the following description, appended claims and accompanying drawings, wherein:

FIG. 1 is a schematic diagram showing the system architecture of the apparatus for controlling a stereo 3D display according to a preferred embodiment of the invention;

FIG. 2 is a flowchart showing the procedures of the method for controlling a stereo 3D display according to a preferred embodiment of the invention;

FIG. 3 and FIG. 4 are schematic diagrams showing the conditions for displaying a stereo 3D animation according to a preferred embodiment of the invention; and

FIG. 5 and FIG. 6 are schematic diagrams showing the conditions for displaying a stereo 3D animation in the prior art.

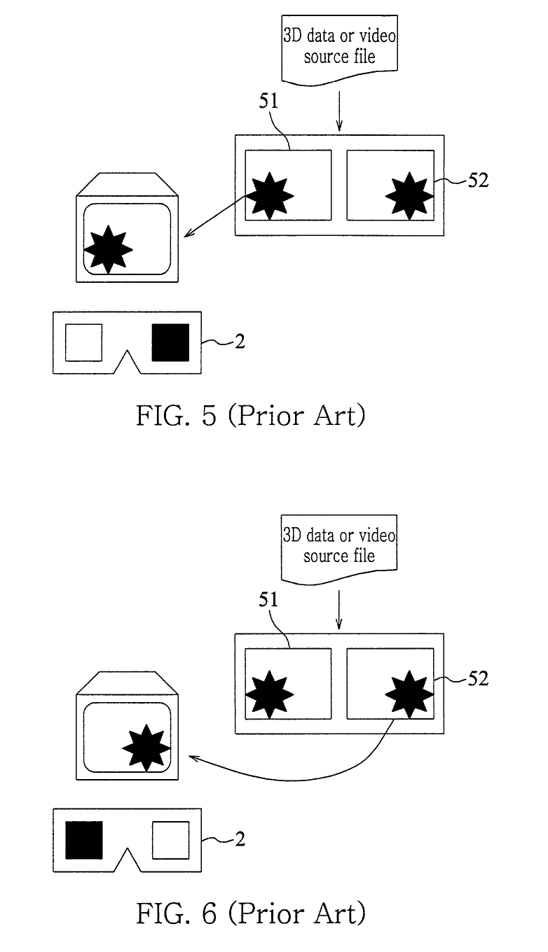

### DETAIL DESCRIPTION OF THE PREFERRED EMBODIMENT

The apparatus and method for controlling a stereo 3D display according to a preferred embodiment of the invention will be apparent from the following detailed description, wherein the same reference numerals relate to the same elements.

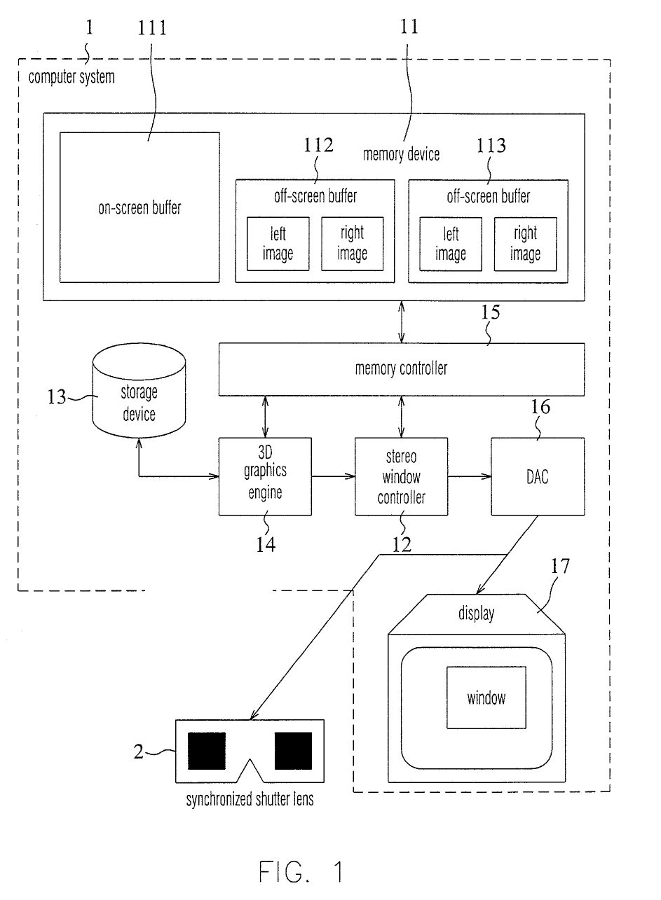

Referring to FIG. 1, the apparatus for controlling a stereo 3D display according to a preferred embodiment of the invention includes a memory device 11 and a stereo window controller 12. The memory device 11 includes an on-screen buffer 111 and two off-screen buffers 112 and 113, respectively. The on-screen buffer 111 stores image data to be displayed on the display 17, which data includes window image data.

It should be noted that the image data of the window could be only a part of the image data to be displayed on the display 17 stored in the on-screen buffer 111. In other words, besides the image data of the window, the on-screen buffer 111 can store other image data to be shown on the display 17, such as the image data for another window, icon or wallpaper.

In the preferred embodiment, the apparatus is implemented in a computer system 1. The computer system 1, co-operating with a synchronized shutter glasses 2, includes a storage device 13, a 3D graphics engine 14, a memory controller 15 and a DAC (Digital Analog Converter) 16.

The storage device 13 can be any kind of primary or secondary computer-readable storage device, such as a hard disc drive, a CD drive or a DVD drive, and can be connected to other devices in the computer system 1 via data transmission buses.

The 3D graphics engine 14 transforms 3D data or data of other video file formats into left image data and right image data according to stereo 3D image processing principles. The 3D graphics engine 14 can be a functional module on a video card or a software module stored in the computer system 1.

The memory controller 15 controls data access and transfer operations in the memory device 11. The memory controller 15 consists of specific circuitry, which interprets requests from other devices in the computer system 1, and locates data addresses in the memory to read/write data from/to the memory device 11.

The DAC 16 transforms the digital image data stored in the on-screen buffer 111 into analog signals, the analog signals are then displayed on the display 17. At the same time, the DAC 16 also sends a synchronization signal to the synchronized shutter glasses 2, so that vertical retrace can be synchronized with the alternative on-off operations of the left and right shutters of the synchronized shutter glasses 2.

It should be noted that one might integrate the memory device 11 and the stereo window controller 12 together with the 3D graphics engine 14, the memory controller 15 and the DAC 16 on a single circuit board or in a single chipset. The persons skilled in the art could implement various designs without departing from the scope of the invention.

In the preferred embodiment, the memory device 11 is provided a double-buffer architecture to enhance the data-processing efficiency. The memory device 11 has two off-screen buffers 112 and 113. One off-screen buffer stores the left image data and the right image data of a current frame, and another off-screen buffer stores left image data and right image data of the next frame of the current frame. The left image data and the right image data of the current frame are alternatively transferred to the on-screen buffer by BITBLT operations as the window image data. When the left image data and the right image data of the next frame are fully prepared, the two off-screen buffers are swapped. The detailed descriptions regarding the off-screen buffers will be given later.

The stereo window controller 12 controls the swap operations of the two off-screen buffer 112 and 113 and the BITBLT operations of the left image data and the right image data of the current frame. The detailed descriptions regarding the operations of the stereo window controller 12 will also be given later.

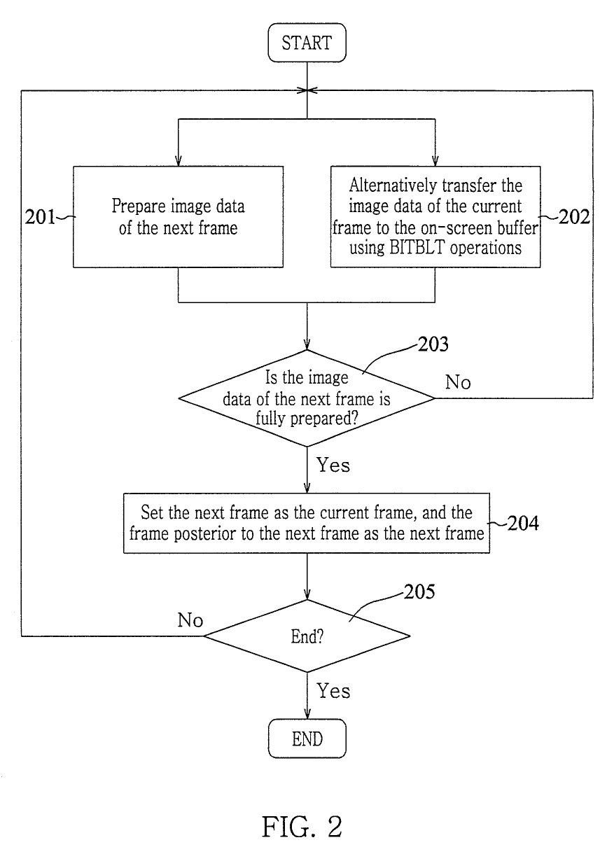

Referring to FIG. 2, in the method for controlling a stereo 3D display according to the preferred embodiment of the invention, the step 201 stores the left image data and the right image data of the current frame in one off-screen buffer, and the left image data and the right image data of the next frame in another off-screen buffer.

In the preferred embodiment, the 3D data or a video source file stored in the storage device 13 are transferred to the 3D graphics engine 14 via buses. The 3D graphics engine 14 then prepares the left image data and the right image data of each frame according to the 3D stereo image principle. Once a frame is prepared completely, the 3D graphics engine 14 prepares its next frame.

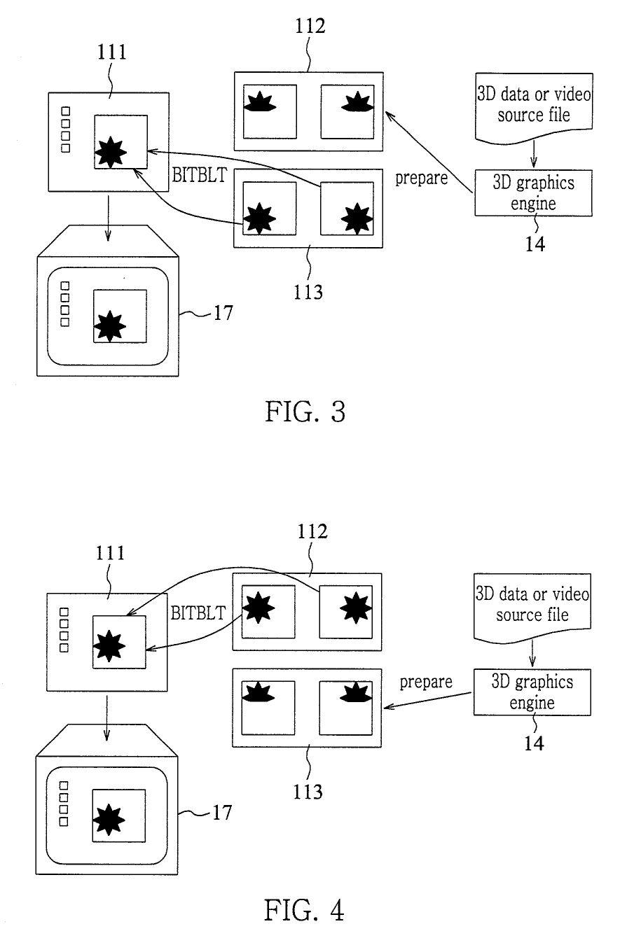

The stereo window controller 12 directs one off-screen buffer to store the data of the current frame, and the other off-screen buffer to store the data of the next frame. The 3D graphics engine 14 writes the data of the next frame under preparation to the off-screen buffer the stereo window controller 12 directed through the memory controller 15. For example, referring to FIG. 3 and FIG. 4, when the image data of the current frame is stored in the off-screen buffer 113, the stereo window controller 12 directs the image data of the next frame under preparation to be stored in the off-screen buffer 112 (as shown in FIG. 3). When the image data of the current frame is stored in the off-screen buffer 112, the stereo window controller 12 directs the image data of the next frame under preparation to be stored in the off-screen buffer 113 (as shown in FIG. 4).

Step 202 alternatively transfers the left image data and the right image data of the current frame to the on-screen buffer as the window image data using BITBLT operations. For example, referring to FIG. 3, since the left image data and the right image data of the current frame are stored in the off-screen 113, the stereo window controller 12 sends the BITBLT requests to the memory controller 15 to alternatively transfer the left image data and the right image data stored in the off-screen buffer 113 to the on-screen buffer 111.

In the preferred embodiment, the stereo window controller 12 considers the vertical retrace of the display 17 while controlling the BITBLT operations. That is, the stereo window controller 12 only sends the BITBLT request right after each vertical retrace. For example, the stereo window controller 12 might send the BITBLT requests in the following sequence:

. . .

BITBLT Request: transfer the LEFT image data to the on-screen buffer as the window image data

(Scan the on-screen buffer from upper left to lower right)

(Vertical retrace)

BITBLT Request: transfer the RIGHT image data to the on-screen buffer as the window image data

(Scan the on-screen buffer from upper left to lower right)

(Vertical retrace)

BITBLT Request: transfer the LEFT image data to the on-screen buffer as the window image data

. . .

Therefore, the window image data in the on-screen buffer 111 are not changed during the scanning of the on-screen buffer 111. The left image and the right image of the current frame can be displayed correctly on the display 17.

Step 203 judges if the image data of the next frame is fully prepared in the off-screen buffer. If the image data of the next frame is not fully prepared, then the method returns to steps 201 and 202 mentioned above. If the image data of the next frame is fully prepared, then the method proceeds to step 204, wherein the next frame is set as the current frame, and the frame posterior to the next frame is set as the next frame.

Referring to FIG. 4, when the image data of the next frame is fully prepared in the off-screen buffer 112, the 3D graphics engine 14 sends a swap signal to the stereo window controller 12. The stereo window controller 12 then sets the off-screen buffer 112 as the off-screen buffer that stores the current frame and the off-screen buffer 113 as the off-screen buffer that stores the next frame. Then, the stereo window controller 12 controls the BITBLT operations that alternatively transfer the image data from the off-screen buffer 112 to the on-screen buffer 111, and the 3D graphics engine 14 prepares the image data of the next frame in the off-screen buffer 113.

Step 205 judges whether or not the whole procedure comes to end. For example, if the user inputs a “stop” request to stop playing the animation, or the last frame of the animation has been processed, then the whole stereo 3D control method ends. Otherwise, the method returns to steps 201 and 202.

To sum up, the stereo window controller 12 controls the following operations in the preferred embodiment:

(1) the swap operations, which determine which one of the two off-screen buffers stores the left image data and the right image data of the current frame; and

(2) the BITBLT operations, which alternatively transfers the left image data and the right image data of the current frame to the on-screen buffer as the window image data while considering the vertical retraces.

Therefore, since the image on the display always refers to the on-screen buffer, and the window image data are updated by BITBLT operations, the apparatus and method for controlling a stereo 3D display according to the preferred embodiment of the invention can display a stereo 3D animation in a window.

While the invention has been described with reference to a preferred embodiment, this description is not intended to be construed in a limiting sense. Various modifications of the embodiment will be apparent to persons skilled in the art upon reference to the description. It is therefore intended that the appended claims encompass any such modifications.

What is claimed is:

1. An apparatus for controlling a stereo 3D display, comprising:
an on-screen buffer for storing screen image data, the screen image data comprising window image data;
two off-screen buffers with double-buffer architecture, wherein one off-screen buffer stores the left image data and the right image data of a current frame, and another off-screen buffer stores the left image data and the right image data of the next frame of the current frame; and
a stereo window controller for controlling swap operations and BITBLT (Bit Block Transfer) operations, wherein the swap operations determine which one of the two off-screen buffers stores the left image data and the right image data of the current frame, and the BITBLT operations alternatively transfer the left image data and the right image data of the current frame to the on-screen buffer as the window image data.

2. The apparatus according to claim 1, further comprising:
a 3D graphics engine for preparing the left image data and the right image data of the next frame.

3. The apparatus according to claim 2, wherein the stereo window controller controls the swap operations according to swap signals from the 3D graphics engine.

4. The apparatus according to claim 1, further comprising:
a memory controller for performing the BITBLT operations according to requests from the stereo window controller.

5. The apparatus according to claim 1, wherein the stereo window controller considers vertical retraces of the stereo 3D display while controlling the BITBLT operations.

6. The apparatus according to claim 1, wherein the on-screen buffer and the off-screen buffers are different memory blocks in a memory device.

7. A method for controlling a stereo 3D display, comprising:
storing the left image data and the right image data of a current frame in one of two off-screen buffers with double-buffer architecture;
preparing the left image data and the right image data of the next frame of the current frame in another one of two off-screen buffers;
alternatively transferring the left image data and the right image data of the current frame to an on-screen buffer by BITBLT operations as window image data; and
performing a swap operation to swap the off-screen buffer storing the left image data and the right image data of the current frame.

8. The method according to claim 7, further comprising,
considering vertical retraces of the stereo 3D display while transferring the left image data and the right image data of the current frame to the on-screen buffer by BITBLT operations.

9. The method according to claim 7 wherein the BITBLT operations and the swap operation are controlled by a stereo window controller.

10. The method according to claim 7, wherein the left image data and the right image data of the next frame are prepared by a 3D graphics engine.

11. The method according to claim 7, further comprising:
after the left image data and the right image data of the next frame being fully prepared, setting the next frame as the current frame, and setting the frame posterior to the next frame as the next frame.

12. A video card, comprising:
an on-screen buffer for storing screen image data, the screen image data comprising window image data;
two off-screen buffers with double-buffer architecture, wherein one off-screen buffer stores the left image data and the right image data of a current frame, and another off-screen buffer stores the left image data and the right image data of the next frame of the current frame;
a stereo window controller for controlling swap operations and BITBLT (Bit Block Transfer) operations, wherein the swap operations determine which one of the two off-screen buffers stores the left image data and the right image data of the current frame, and the BITBLT operations alternatively transfer the left image data and the right image data of the current frame to the on-screen buffer as the window image data;
a 3D graphics engine for preparing the left image data and the right image data of the next frame; and
a memory controller for performing the BITBLT operations according to requests from the stereo window controller.

13. The video card according to claim 12, wherein the stereo window controller considers vertical retraces of the stereo 3D display while controlling the BITBLT operations.

14. The video card according to claim 12, wherein the stereo window controller controls the swap operations according to swap signals from the 3D graphics engine.

15. The video card according to claim 12, wherein the on-screen buffer and the off-screen buffers are different memory blocks in a memory device.
